(19) United States
(12) Patent Application Publication
(10) Pub. No.: US 2008/0049194 A1
(43) Pub. Date: Feb. 28, 2008

(54) Projector having mechanism for lowering its surface temperature and method using the same

(75) Inventors: Shun-Chieh Yang, Sinjhuang City (TW); Hung-Jen Wei, Nantou City (TW)

Correspondence Address: REED SMITH LLP, Suite 1400, 3110 Fairview Park Drive, Falls Church, VA, 22042, US

(73) Assignee: BenQ Corporation

(21) Appl. No.: 11/892,519

(22) Filed: Aug. 23, 2007

(30) Foreign Application Priority Data
Aug. 23, 2006 (TW) 95130945

(51) Int. Cl. G03B 21/16

(52) U.S. Cl. 353/61

(57) ABSTRACT

A projector having a mechanism for lowering its surface temperature is provided. The projector includes a fan, a side casing, and an air guide. The side casing is placed adjacent to the fan and includes a first section and a second section. The first section includes at least one air inlet, and the second section includes at least on air outlet. The air guide is disposed above the fan and connected to the first section. The air guide is configured to guide high temperature air in the projector. By using the air guide to guide the high temperature air, the air inlet to introduce low temperature air into the projector, and the air out let to exhaust high temperature air, the temperature of a top surface of the projector is lowered.

### RELATED APPLICATION

This application claims the right of priority based on Taiwan Patent Application No. 095130945 entitled “PROJECTOR HAVING MECHANISM FOR LOWERING ITS SURFACE TEMPERATURE AND METHOD USING THE SAME”, filed on Aug. 23, 2006, which is incorporated herein by reference and assigned to the assignee herein.

### FIELD OF INVENTION

The present invention generally relates to a projector, and more particularly, to a projector having mechanism for lowering its surface temperature.

### BACKGROUND OF THE INVENTION

A projector usually generates heat energy since a light bulb operates. If the heat energy cannot be efficiently dissipated, the performance of the projector will therefore be decreased, or even worse, the projector will be damaged. For this reason, a heat dissipation system is critical for the projector to operate normally. As shown in FIG. 1, a conventional projector 100 dissipates heat by air flowing (X1) to keep normal operation temperature in a system. A fan usually continuously works to draw low temperature air from an inlet 130 and the low temperature air is circulated within the projector, so the high temperature air in the projector is driven to flow out of the projector through the outlet 120 to facilitate interior heat dissipation and also cool the light bulb.

However, the above-mentioned design will substantially increase surface temperature of a top cover (or bottom cover) of the outlet close to the fan, and further possibly endanger user's safety. As a result, insulating air or employing higher heat-conducting material, such as aluminum, tagger, or other metal sheets, to distribute hot spots and uniform heat and temperature is a common design for cooling a casing. Although the design of air insulation and utilization of higher heat-conducting material shows certain efficiency, the manufacturing cost of projectors also increases.

Therefore, there is a need to provide a projector having a mechanism for efficiently lowering its surface temperature without adding much cost of additional heat-conducting materials.

### SUMMARY OF THE INVENTION

In viewing the drawbacks of prior arts, the present invention provides a projector having a mechanism for lowering its surface temperature.

One aspect of the present invention is to provide a projector including a fan, a side casing, and an air guide. The side casing is placed adjacent to the fan and includes a first section and a second section. The first section has at least one air inlet, and the second section has at least one air outlet. The air guide is disposed above the fan and connected to the first section to guide high temperature air out of the projector.

Another aspect of the present invention is to provide a method for lowering temperature on a top surface of a projector. The projector includes a fan, a side casing, and an air guide. The side casing is adjacent to the fan and includes a first section and a second section. The first section has at least one air inlet, and the second section has at least one air outlet. The air guide is disposed above the fan and connected to the first section. The method includes the steps of guiding high temperature air in the projector by the air guide, and introducing low temperature air from the first section so that high temperature air in the projector is exhausted through the air outlet of the second section to lower the temperature on the top casing surface.

### BRIEF DESCRIPTION OF THE DRAWINGS

FIG. 1 illustrates a side-view view of a projector in accordance with the prior art;

FIG. 2 illustrates a side view of a projector in accordance with an embodiment of the present invention; and

FIG. 3 illustrates an exterior appearance of a projector in accordance with an embodiment of the present invention.

### DETAILED DESCRIPTION OF THE INVENTION

The present invention discloses a projector having a mechanism for lowering its surface temperature. For better understanding, please refer to the following descriptions in conjunction with the accompanied drawings.

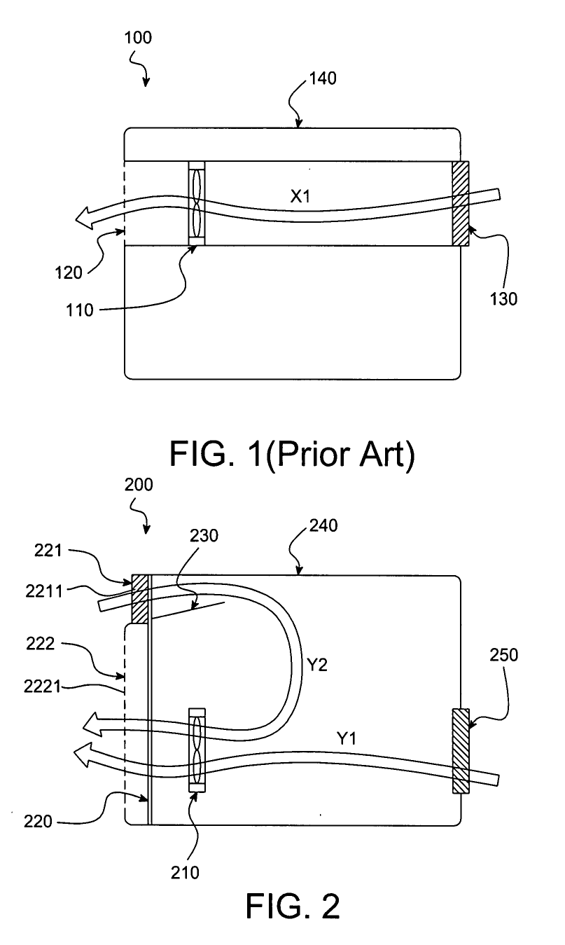

FIG. 2 illustrates a side view of a projector 200 in accordance with an embodiment of the present invention. The projector 200 includes a fan 210, a side casing 220, and an air guide 230. The side casing 220 is adjacent to the fan 210 and has a first section 221 and a second section 222. The second section 222 has at least one air outlet 2221. The fan 210 is facing the second section 222 and guiding high temperature air out of the projector 200. The first section 221 sets at least one air inlet 2211 for guiding low temperature air into the projector 200 when the fan 210 is working. The air guide 230 is disposed above the fan 210 and connects between the first section 221 and the second section 222. The air guide 230 and the first section 221 are arranged to form an angle greater than 0 degree. The air guide 230 guides low temperature air passing near the top cover 240 then getting into the projector 200 when the fan 210 is working. Similar to the conventional projector 100 shown in FIG. 1, the projector 200 has an inlet 250. The inlet 250 cooperates with the fan 210 causing the air circulating in the projector 200. For example, the fan 210 draws ambient air (i.e. low temperature air) into the projector 200 through the inlet 250, and then the low temperature air flows along the path indicated as Y1 and through the heat generated sources, such as light bulb, motor etc. (not shown) within the projector 200, to carry heat energy away. The air guide 230 is disposed to guide the low temperature air from the air inlet 2211 into the projector 200 and also guide the high temperature air out of the projector 220 to the air outlet 2221. When air flows along the path, Y1, a suction effect is induced such that the low temperature air can be introduced from the air inlet 2211 at the first section 221 along the path indicated as Y2. The low temperature air from the air inlet 2211 is then mixed with the high temperature air at the air outlet 2221 of the second section 222, so that the surface temperature of the top cover 240 near the fan 210 can be efficiently reduced.

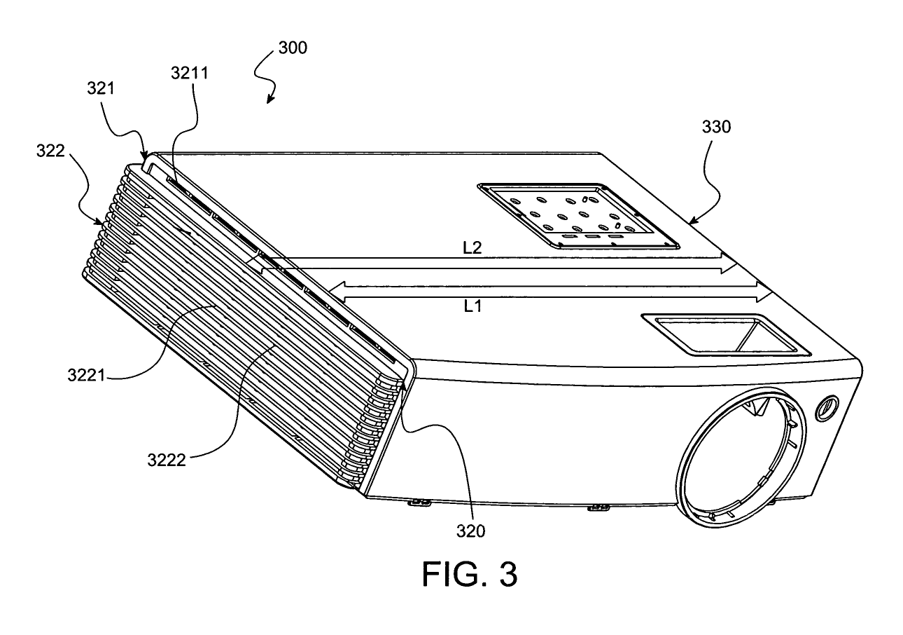

FIG. 3 illustrates an exterior appearance of a projector 300 in accordance with an embodiment of the present invention. The projector 300 includes a side casing 320. The side casing 320 includes a first section 321 and a second section 322. The first section 321 has at least one air inlet 3211, and the second section 322 has at least one air outlet 3221. As shown in FIG. 3, the first section 321 is parallel to but not coplanar with the second section 322. That is, the length (L1) from the first section 321 to the sidewall 330 of the projector 300 is shorter than the length (L2) from the second section 322 to the sidewall 330. In this embodiment, L1 is about 2.0 cm shorter than L2 so as to facilitate the introduction of the low temperature air from the air inlet 3211, and accordingly, increase the air-flowing efficiency within the projector 300. Please note that the air guide or the side casing can be modified to include any arrangement or modification producing the same effect. Moreover, as shown in FIG. 3, the second section 322 also includes a plurality of ventilation apertures 3222, which is perpendicular to the air outlet 3221. For example, the second section 322 of the side casing 320 can have two pieces designed similar to a Venetian blind, which are perpendicular to each other so that the light generated by a light source (such as a light bulb) can be shaded, and the vented high temperature air will not return back to the projector 300 through the second section 322.

By means of the detailed descriptions of what is presently considered to be the most practical and preferred embodiments of the subject invention, it is expected that the features and the gist thereof be clearly described. Nevertheless, these embodiments are not intended to be construed in a limiting sense. Instead, it will be well understood that any analogous variations and equivalent arrangements will fall within the spirit and scope of the invention.

What is claimed is:

1. A projector, comprising:
a fan;
a side casing adjacent to said fan, said side casing comprising a first section and a second section, said first section having at least one air inlet and said second section having at least one air outlet; and
an air guide disposed above said fan and connected to said first section to guide high temperature air out of the projector.

2. The projector of claim 1, wherein said air guide and said side casting are arranged to form an angle.

3. The projector of claim 1, wherein said air inlet is configured to introduce low temperature air, and said air outlet is configured to exhaust high temperature air.

4. The projector of claim 1, wherein said first section is parallel to but not coplanar with said second section.

5. The projector of claim 1, wherein said second section further comprises a plurality of ventilation apertures perpendicular to said air outlet.

6. A method for lowering temperature on a top casing surface of a projector, said projector comprising a fan, a side casing adjacent to said fan, said side casing including a first section and a second section; said first section having at least one air inlet and the second section having at least one air outlet, and an air guide disposed above said fan and connected to said first section, said method comprising:
(a) guiding high temperature air out of said projector by said air guide; and
(b) introducing low temperature air from said first section so that high temperature air in said projector is exhausted through said air outlet of said second section to reduce temperature on said top casing surface.

7. The method of claim 6, wherein said air guide and said side casing are arranged to form an angle.

8. The method of claim 6, wherein said first section is arranged to be parallel to but not coplanar with said second section.

9. The method of claim 6, wherein said second section further comprises a plurality of ventilation apertures perpendicular to said air outlet.

10. A projector, comprising:
a top cover;
a fan;
a side casing having an air inlet and an air outlet, the air outlet disposed adjacent to said fan;
an air guide connecting to the side casing and disposed between the air inlet and the air outlet;
wherein when the fan works, a first air flow comes from the air inlet and passes near the top cover and a second air flow gets out of the projector through the air outlet.

11. The projector of claim 10, wherein the first air flow is guided by the air guide.

12. The projector of claim 10, wherein the air inlet is parallel to but not coplanar
with the air outlet.

13. The projector of claim 10, wherein the side casing connects a first end of the top cover, the projector further comprising:
an inlet connecting to a second end of the top cover;
wherein when the fan works, a third air flow gets into the projector from the inlet.
